(19) United States
(12) Patent Application Publication
(10) Pub. No.: US 2022/0196120 A1
(43) Pub. Date: Jun. 23, 2022

(54) JM111804 Meshing Plate Gear

(71) Applicant: Jacob Myklebust, Sapulpa, OK (US)

(72) Inventor: Jacob Myklebust, Sapulpa, OK (US)

(21) Appl. No.: 17/128,838

(22) Filed: Dec. 21, 2020

(51) Int. Cl. F16H 3/42; F16H 55/17

(52) U.S. Cl. CPC F16H 3/426; F16H 3/423; F16H 55/17

(57) ABSTRACT

This invention is a new type of gear that will allow any non-planetary multi ratio gearing system to be configured in a superior way by consolidating half of the separate gears into one gear. Example: A five speed transmission needs ten separate gears for each drive ratio. One drive gear and one take-off gear for each speed. This invention consolidates either the five drive or the five take-off gears into a single gear by placing the meshing teeth on the surface of a single plate in concentric circles or rows. Each row will take the place of one gear.

### BACKGROUND

This invention applies to multi ratio power transmissions. Current transmission are heavy and expensive to produce and maintain. In industrial situations where multiple power take-off are beneficial there is currently no solution that can provide multiple ratio options for each separate take-off.

This invention is intended to simplify design, production, and ease of maintenance of power transmissions and also to provide previously unavailable options to have multiple take power take-off each with independent gearing ratios. It is a meshing gear so it will be suitable for high torque as well as lower torque applications.

### BRIEF SUMMARY

All non-Planetary multi ratio transmissions have 2 meshing gears for each desired ratio: one for the drive gear and one take off gear.

The invention will allow one set of those gears to be combined into a single gear.

This will simplify and lighten the overall transmission units. It will simplify and cheapen production and maintenance also.

### BRIEF DESCRIPTION OF DRAWINGS

FIG. 1: Most simple form of the Meshing Plate Gear with 3 ratios.

FIG. 2: Simple spiral tooth pattern with constant engagement and 4 ratios.

FIG. 3: Tiered Plate with spiral tooth pattern and constant engagement (increased ratio differential without increasing plate diameter).

FIG. 4: Tiered Plate with spiral tooth pattern and constant engagement. Multiple power take-off configuration.

FIG. 5: Simple 2 ratio constant engagement with rudimentary Beveled (angled) teeth.

FIG. 6: Simple 3 ratio intermittent engagement configuration where the plate is an intermediary between the drive and take-off gear.

### DETAILED DESCRIPTION

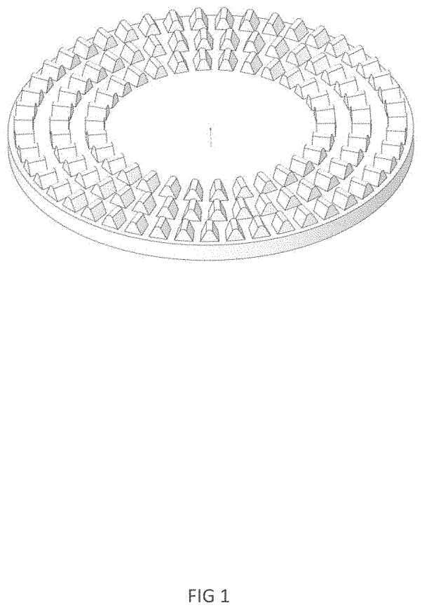

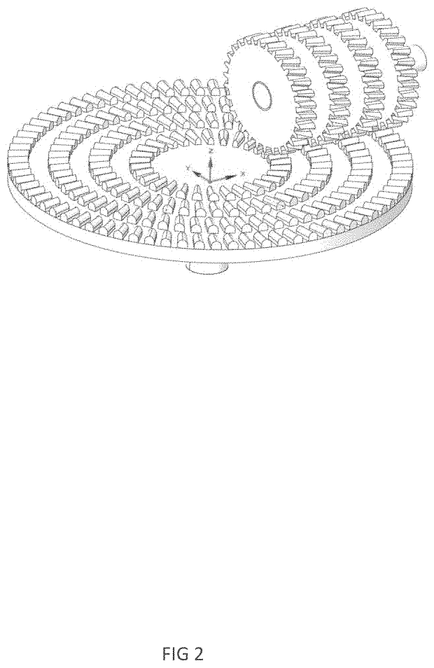

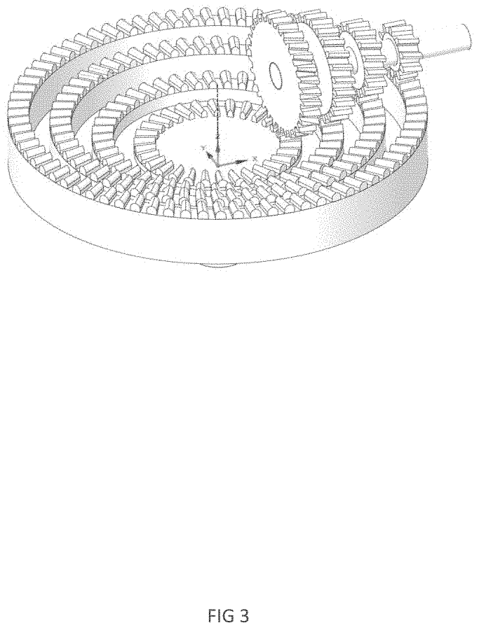

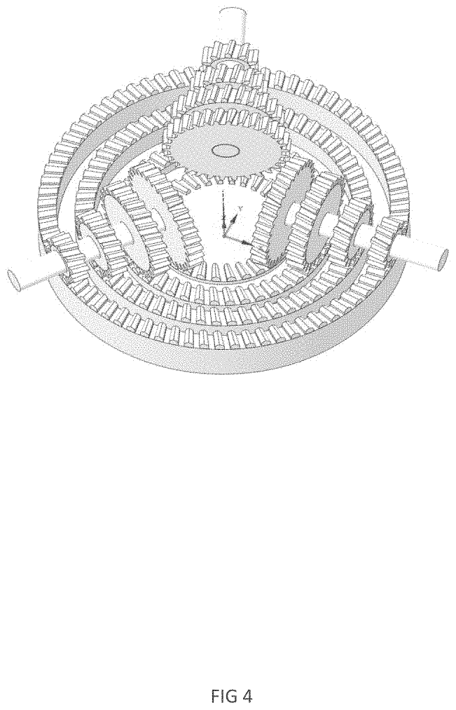

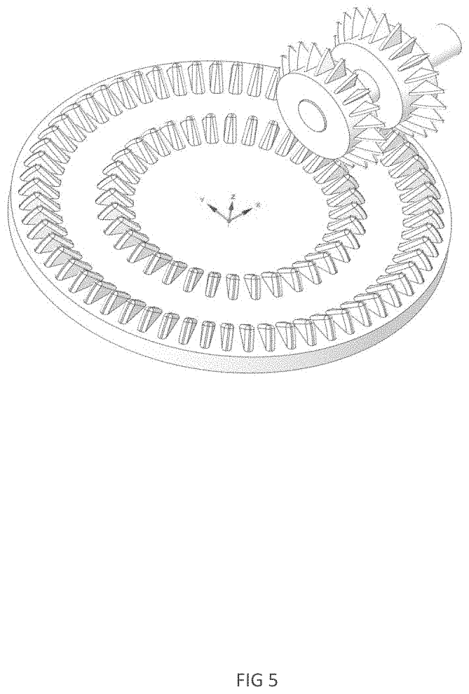

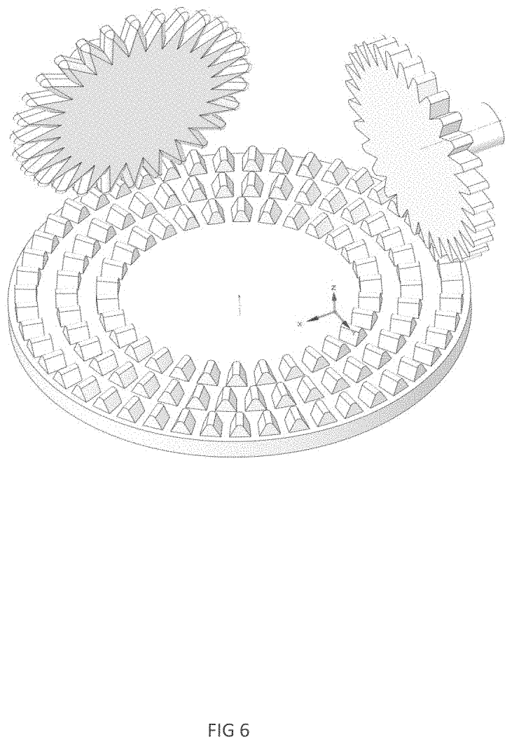

The invention is a gear in which the teeth of the gear are situated on the face of a flat plate. The teeth protrude perpendicular to the surface of the plate resulting in a perpendicular relationship between the drive and take-off gears (FIG. 1). The different gearing ratios are achieved by configuring the teeth in concentric circles or rows of teeth (FIG. 1). It can be configured for constant meshing transmissions like those found in automobiles (FIG. 2). The difference in gears ratios can be further increased by creating tiers of the rows by elevating the teeth vertically from the face (FIG. 3). Each row can be individually customized. This will improve power transmissions in several ways. It will reduce the number of over all parts by replacing one set of gears with one plate gear. It can be either the drive or the take-off gear. When it is used as the drive gear it can be configured to have multiple take off gears by adding gear sets radially about the plate (FIG. 4). Each one of the take-off shafts will have independent ratio capabilities. It can also be used as an intermediate gear between separate drive and take-off shafts (FIG. 6). By combining several gears into one will reduce the overall weight of the transmission unit. Fewer moving parts reduces complexity allowing for more simple and compacted designs resulting in reduced manufacture and maintenance costs. It can be configured using any current tooth configuration (FIG. 5) shows angled or beveled teeth.

1. The inventions unique innovation is placing the meshing teeth in concentric circles (rows) on the face of the plate thereby combining the function of several individual gears into one unit. Current transmissions need 2 shafts each shaft has a separate gear for each speed. Pairs of gears of varying diameter mesh to provide desired ratios. This invention will replace one complete shaft of independent gears with a single plate gear. This will:
1 reduce total number of parts
2 consolidate weight
3 simplify design
4 ease maintenance and production.
